(19) United States
(12) Patent Application Publication
(10) Pub. No.: US 2018/0081180 A1
(43) Pub. Date: Mar. 22, 2018

(54) OBSERVATION DEVICE, GLASSES-TYPE TERMINAL DEVICE, OBSERVATION SYSTEM, OBSERVATION METHOD, SAMPLE POSITION ACQUISITION METHOD, RECORDING MEDIUM RECORDING OBSERVATION PROGRAM, AND RECORDING MEDIUM RECORDING SAMPLE POSITION ACQUISITION PROGRAM

(71) Applicant: Olympus Corporation, Tokyo (JP)

(72) Inventors: Hiroki AMINO, Tokyo (JP); Hideaki MATSUOTO, Tokyo (JP); Tsuyoshi YAJI, Kawagoe-Shi (JP); Osamu NONAKA, Sagamihara-shi (JP)

(21) Appl. No.: 15/709,388

(22) Filed: Sep. 19, 2017

(30) Foreign Application Priority Data
Sep. 21, 2016 (JP) 2016-184490

(51) Int. Cl. G02B 27/01; G06F 3/03; G06F 3/042

(52) U.S. Cl. CPC G02B 27/0179; G02B 27/0176; G02B 2027/0178; G06F 3/0425; G06F 3/0304

(57) ABSTRACT

An observation device includes: an image acquisition portion configured to acquire an image in a direction where a culture vessel is mounted; a communication portion configured to communicate with a glasses-type terminal device including a display portion; and a control portion configured to acquire information concerning a sample position at the time of performing work on a sample in the culture vessel from the glasses-type terminal device, control the image acquisition portion to acquire a picked-up image of a position corresponding to the sample position, and cause the glasses-type terminal device to display the image pickup result, and can improve not only observation but also workability.

### CROSS REFERENCE TO RELATED APPLICATION

This application claim is benefit of Japanese Application No. 2016-184490 in Japan on Sep. 21, 2016, the contents of which are incorporated by this reference.

### BACKGROUND OF THE INVENTION

### 1. Field of the Invention

The present invention relates to an observation device, a glasses-type terminal device, an observation system, an observation method, a sample position acquisition method, a recording medium recording an observation program, and a recording medium recording a sample position acquisition program.

### 2. Description of the Related Art

Generally, for cell culture, a proliferation environment needs to be strictly managed, and an incubator or the like is adopted. In the incubator, proliferation conditions such as a temperature, humidity, a carbon dioxide concentration can be stably controlled, and by arranging a culture vessel inside the incubator, culture under a managed environment is made possible.

An observation device configured to observe a state of cells inside a culture vessel arranged inside such an incubator has been developed.

Japanese Patent No. 4490154 discloses an observation device with a camera device arranged inside an incubator.

### SUMMARY OF THE INVENTION

An observation device according to one aspect of the present invention includes: an image acquisition portion configured to acquire an image in a direction where a culture vessel is mounted; and a control portion configured to control the image acquisition portion when a sample position at the time of performing work on a sample in the culture vessel is given, and cause a picked-up image corresponding to the sample position to be acquired.

In addition, a glasses-type terminal device according to one aspect of the present invention is a glasses-type terminal device used during work for culture, and includes: an information acquisition portion configured to acquire information concerning work on a sample in a culture vessel; and a work determination portion configured to determine the work based on the information concerning the work, and acquire position information of a sample position at the time of performing the work on the sample.

Furthermore, an observation device according to another aspect of the present invention includes: an image acquisition portion configured to acquire an image in a direction where a culture vessel is mounted; a communication portion configured to communicate with a glasses-type terminal device including a display portion; and a control portion configured to acquire information concerning a sample position at the time of performing work on a sample in the culture vessel from the glasses-type terminal device, control the image acquisition portion to acquire a picked-up image of a position corresponding to the sample position, and cause the glasses-type terminal device to display an image pickup result.

In addition, an observation system according to another aspect of the present invention includes: a glasses-type terminal device including a display portion; an image acquisition portion configured to acquire an image in a direction where a culture vessel is mounted; a communication portion configured to communicate with the glasses-type terminal device; and a control portion configured to acquire information concerning a sample position at the time of performing work on a sample in the culture vessel from the glasses-type terminal device, control the image acquisition portion to acquire a picked-up image of a position corresponding to the sample position, and cause the glasses-type terminal device to display an image pickup result.

In addition, an observation method according to another aspect of the present invention includes: a procedure configured to acquire a sample position at the time of performing work on a sample in a culture vessel; and a procedure configured to control an image acquisition portion configured to acquire an image in a direction where the culture vessel is mounted, and cause a picked-up image corresponding to the sample position to be acquired.

Further, a sample position acquisition method according to another aspect of the present invention includes: a procedure configured to acquire information concerning work on a sample in a culture vessel, by a glasses-type terminal device used during the work for culture; and a procedure configured to determine the work based on the information concerning the work and acquire position information on the sample position at the time of performing the work on the sample.

Furthermore, an observation method according to another aspect of the present invention includes: a procedure configured to acquire information concerning a sample position at the time of performing work on a sample in a culture vessel, by a glasses-type terminal device including a display portion; a procedure configured to control an image acquisition portion configured to acquire an image in a direction where the culture vessel is mounted based on the information concerning the sample position, and cause a picked-up image of a position corresponding to the sample position to be acquired; and a procedure configured to transmit the acquired picked-up image to the glasses-type terminal device and cause the picked-up image to be displayed at the display portion.

In addition, a recording medium recording an observation program according to one aspect of the present invention records a program for causing a computer to execute: a procedure configured to acquire a sample position at the time of performing work on a sample in a culture vessel; and a procedure configured to control an image acquisition portion configured to acquire an image in a direction where the culture vessel is mounted, and cause a picked-up image corresponding to the sample position to be acquired.

Further, a recording medium recording a sample position acquisition program according to one aspect of the present invention records a program for causing a computer to execute: a procedure configured to acquire information concerning work on a sample in a culture vessel, by a glasses-type terminal device used during the work for culture; and a procedure configured to determine the work based on the information concerning the work and acquire position information on the sample position at the time of performing the work on the sample.

Furthermore, a recording medium recording an observation program according to another aspect of the present invention records a program for causing a computer to execute: a procedure configured to acquire information concerning a sample position at the time of performing work on a sample in a culture vessel, by a glasses-type terminal device including a display portion; a procedure configured to control an image acquisition portion configured to acquire an image in a direction where the culture vessel is mounted based on the information concerning the sample position, and cause a picked-up image of a position corresponding to the sample position to be acquired; and a procedure configured to transmit the acquired picked-up image to the glasses-type terminal device and cause the picked-up image to be displayed at the display portion.

The above and other objects, features and advantages of the invention will become more clearly understood from the following description referring to the accompanying drawings.

### BRIEF DESCRIPTION OF THE DRAWINGS

FIG. 1 is a block diagram illustrating an observation device relating to a first embodiment of the present invention;

FIG. 2 is an explanatory drawing illustrating one example of a first observation portion;

FIG. 3 is an explanatory drawing illustrating one example of a second observation portion;

FIG. 4 is an explanatory drawing illustrating an example constituted of a tablet PC or a smartphone or the like as one example of an operation and recording portion 30;

FIG. 5 is an explanatory drawing for describing an operation of an embodiment;

FIG. 6 is an explanatory drawing for describing the operation of the embodiment;

FIG. 7 is an explanatory drawing for describing the operation of the embodiment;

FIG. 8 is a flowchart for describing the operation of the embodiment;

FIG. 9 is a flowchart for describing the operation of the embodiment;

FIG. 10 is an explanatory drawing illustrating one example of a culture vessel;

FIG. 11 is an explanatory drawing illustrating one example of the culture vessel;

FIG. 12 is an explanatory drawing illustrating one example of a determination method of a pipette distal end position in a case of utilizing an index 50 formed on a transparent plate 41f;

FIG. 13 is an explanatory drawing illustrating one example of the determination method of the pipette distal end position in the case of utilizing the index 50 formed on the transparent plate 41f;

FIG. 14 is a flowchart illustrating an operation flow adopted in a second embodiment of the present invention;

FIG. 15 is an explanatory drawing illustrating moving pattern information adopted in a count mode; and

FIG. 16 is an explanatory drawing for describing movement of a camera device 43 in the count mode.

### DETAILED DESCRIPTION OF THE PREFERRED EMBODIMENTS

Hereinafter, embodiments of the present invention will be described in detail with reference to the drawings.

### First Embodiment

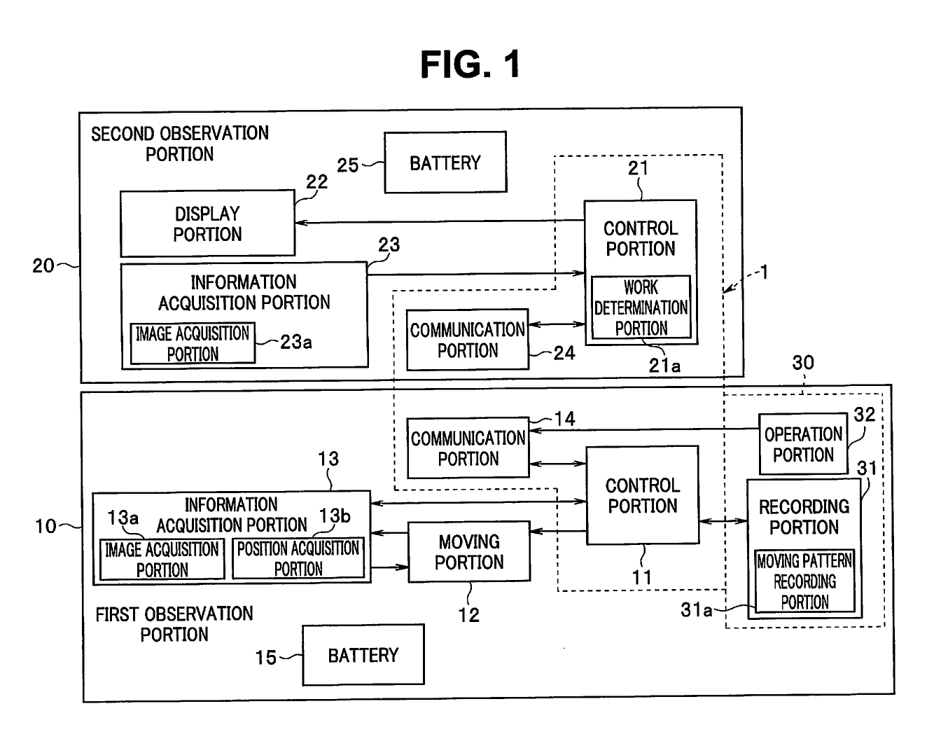

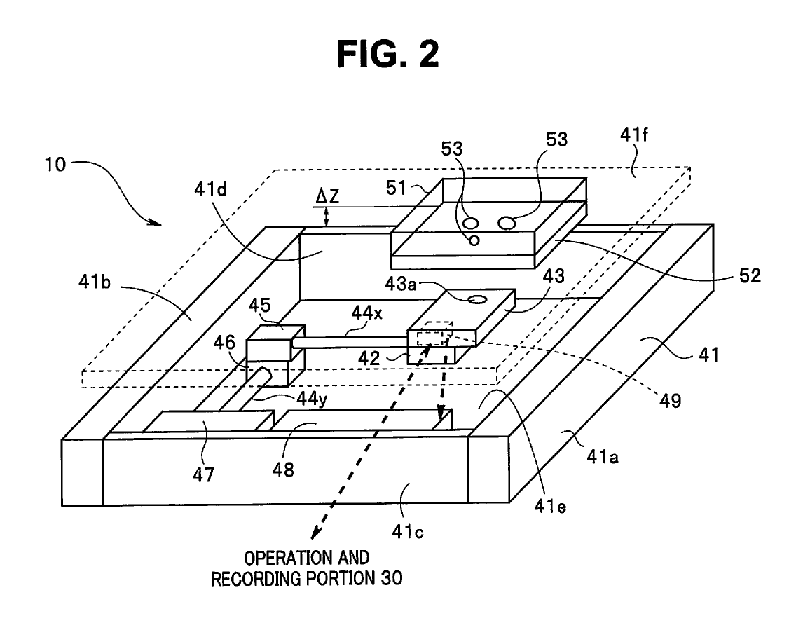

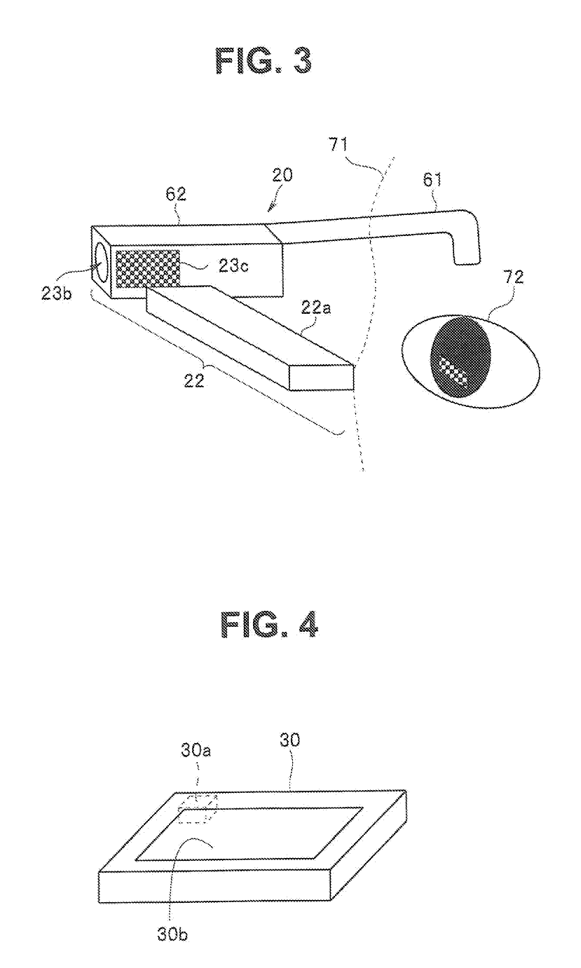

FIG. 1 is a block diagram illustrating an observation device relating to a first embodiment of the present invention. The present embodiment includes a first observation portion (head portion) configured to observe cells under culture and a second observation portion (display portion) for obtaining and confirming an observation result in the first observation portion. FIG. 2 is an explanatory drawing illustrating one example of the first observation portion (head portion), and FIG. 3 is an explanatory drawing illustrating one example of the second observation portion (display portion). Note that, while FIG. 3 illustrates the example of configuring the second observation portion (display portion) by a wearable terminal, various kinds of display devices can be adopted as the second observation portion. Further, as described later, it is also possible to achieve a function of the second observation portion (display portion) by partial function extension of the first observation portion (head portion) and achieve a function of the first observation portion (head portion) by partial function extension of the second observation portion (display portion), thereby omitting one of the observation portions and configuring the embodiment.

In FIG. 1, a first observation portion (head portion) 10 is provided with a control portion 11. The control portion 11 controls respective portions of the first observation portion 10. The control portion 11 may be the one constituted of a processor using a CPU or the like and operated according to a program stored in a memory not illustrated to control the respective portions, or may be partially replaced with an electronic circuit of hardware as needed, and artificial intelligence may be put in charge of some judgement.

The first observation portion (head portion) 10 includes an information acquisition portion 13. The information acquisition portion 13 includes an image acquisition portion 13a and a position acquisition portion 13b. The image acquisition portion 13a can be constituted of a camera device including an image pickup portion constituted of an image pickup lens and an image pickup device not illustrated for example, and is capable of picking up an image of an object, acquiring electric picked-up image data and outputting the data as image output.

A moving portion 12 is controlled by the control portion 11, and can move a visual field of an image picked up by the image acquisition portion 13a. For example, the moving portion 12 can change a position of the visual field by moving the image pickup lens. For example, the moving portion 12 moves the image pickup lens in a predetermined range in an x direction and a y direction orthogonal to a zoom and focus direction. Thus, the position of the visual field is changed. In addition, by moving the image pickup lens in the zoom and focus direction, a view angle and a focus or the like can be also set. Note that the image acquisition portion 13a can pick up a telescopic image at a high magnification, and a contrivance not limited to that is possible by utilizing a zoom function and compound eyes or the like, even though a visual field range is relatively narrow.

The position acquisition portion 13b can acquire information on the visual field range of the image acquisition portion 13a based on the picked-up image by the image acquisition portion 13a or information on positions of the image pickup lens and the image pickup device configuring the image acquisition portion 13a, and feeds back the information to the moving portion 12 as position information. The moving portion 12 can perform control such that the image is picked up surely in a specified visual field range by feedback control. Note that, in a case where movement can be controlled by recognizing a movement control amount in the moving portion 12, the position acquisition portion 13b can be omitted.

An operation portion 32 can receive a user operation and output an operation signal based on the user operation to a communication portion 14. When the operation signal is received from the operation portion 32, the communication portion 14 gives the received operation signal to the control portion 11. Thus, the control portion 11 can control the respective portions according to the user operation. For example, in the case where movement control information concerning the movement of the visual field range of the image acquisition portion 13a is outputted as the operation signal by the operation portion 32, the control portion 11 controls the moving portion 12 so as to change the visual field range of the image acquisition portion 13a based on the received movement control information.

The control portion 11 can give the picked-up image from the information acquisition portion 13 to a recording portion 31 to be recorded. The recording portion 31 records the picked-up image in a predetermined recording medium. In addition, the recording portion 31 is provided with a moving pattern recording portion 31a. In the moving pattern recording portion 31a, information (moving pattern information) on a moving pattern for changing the visual field range of the image acquisition portion 13a is recorded. By reading the moving pattern information from the moving pattern recording portion 31a and controlling the moving portion 12 according to the moving pattern based on the information, the control portion 11 can change the visual field range of the image acquisition portion 13a according to the moving pattern.

Note that the first observation portion (head portion) 10 is provided with a battery 15. The battery 15 generates power needed for driving the first observation portion 10 and supplies the power to the respective portions. Note that generation of the power of the battery 15 is controlled by a manual machine switch or the control portion 11.

A second observation portion (display portion) 20 is provided with a control portion 21. The control portion 21 controls respective portions of the second observation portion 20. The control portion 21 may be the one constituted of a processor using a CPU or the like and operated according to a program stored in a memory not illustrated to control the respective portions.

The second observation portion 20 (display portion) is provided with a communication portion 24. The communication portion 24 can send and receive information by communication with the communication portion 14 of the first observation portion 10. In addition, the second observation portion 20 is provided with a display portion 22. The control portion 11 of the first observation portion 10 can give the picked-up image acquired by the information acquisition portion 13 to the second observation portion 20 through the communication portions 14 and 24. The control portion 21 can give the picked-up image received through the communication portions 14 and 24 to the display portion 22 to be displayed. In this way, the picked-up image of the object acquired by the information acquisition portion 13 of the first observation portion 10 can be displayed at the display portion 22 of the second observation portion 20.

The second observation portion (display portion) 20 is provided with a battery 25. The battery 25 generates power needed for driving the second observation portion 20 and supplies the power to the respective portions. Note that generation of the power of the battery 25 is controlled by the control portion 21.

In the present embodiment, the second observation portion 20 (display portion) is also provided with an information acquisition portion 23. The information acquisition portion 23 includes an image acquisition portion 23a. The image acquisition portion 23a can be constituted of a camera device and the like including an image pickup portion constituted of an image pickup lens and an image pickup device not illustrated for example, and is capable of picking up an image in a relatively wide visual field range. For example, the image acquisition portion 23a may have a wide visual field range including the visual field range in the image acquisition portion 13a of the first observation portion 10, which is the visual field range where work on the object of the image acquisition portion 13a can be observed. Note that the information acquisition portion 23 may include a voice acquisition portion configured to acquire uttered voice of a user.

The picked-up image from the information acquisition portion 23 is supplied to the control portion 21. The control portion 21 includes a work determination portion 21a. The work determination portion 21a can make a determination (work determination) concerning the work of the user on the object of the image acquisition portion 13a by image analysis of the picked-up image from the information acquisition portion 23. For example, in the case where the user executes pipetting work on the object of the image acquisition portion 13a, the work determination portion 21a can determine that the work of the user is the pipetting work (for example, in the case of specifying that effect or the like, start communication, voice determination and image determination or the like), and determine a position (referred to as a work target position, hereinafter) of the object which is a target of the pipetting work. The work determination portion 21a can transmit position information of the work target position which is a determination result to the control portion 11 of the first observation portion 10 through the communication portions 24 and 14. That is, the observation device includes the image acquisition portion 13a configured to acquire the image from a part where a culture vessel is mounted, and includes the control portion configured to control the image acquisition portion when the information on a sample position (the above-described work target position) at the time of performing the work on a sample in the culture vessel in the communication portion or the like (the determination may be made in a present device without performing the communication), and cause the picked-up image corresponding to the sample position to be acquired.

Note that, while the example of determining the pipetting work is illustrated in the embodiment, the work determination is not limited to the example. For example, it is also possible to determine the work at the time of collecting cells by a spatula, and the work determination for various kinds of the work concerning cell culture is possible.

Further, in the case where the information acquisition portion 23 includes a voice acquisition portion, the work determination portion 21a may analyze voice uttered by the user and determine the work. In this case, the work determination portion 21a can determine content of the work and the work target position by a voice recognition result. In addition, the work determination portion 21a may also determine the work by image and voice analysis. For example, in the case where the user confirms the cells in a state of shaking and tilting the culture vessel, the work determination portion 21a may determine such work of the user by the image analysis, and determine the work content and the work target position by the determination of the voice specifying the work target position, which is uttered by the user. When the control portion 11 puts the artificial intelligence or the like in charge of some judgement, a difference between correct determination and wrong determination is learned by features of the voice and the operation of the user and deep learning is performed to improve determination accuracy.

In the present embodiment, the control portion 11 controls the moving portion 12 based on the position information transmitted from the second observation portion 20, and moves the position of the visual field range of the image acquisition portion 13a such that the work target position is included in the visual field range.

Note that, while FIG. 1 illustrates the example of providing the control portion 11 in the first observation portion 10 and providing the control portion 21 in the second observation portion 20 respectively, the control portion may be provided in either one of the first observation portion 10 and the second observation portion 20 to control the respective portions of the first observation portion 10 and the second observation portion 20 by the control portion, and a control portion 1 may be constituted of the control portions 11 and 21 and the communication portions 14 and 24 to control the respective portions of the first observation portion 10 and the second observation portion 20 by the control portion 1.

FIG. 2 illustrates one example of the first observation portion 10 in FIG. 1. An observation target of the first observation portion 10 is a sample in a culture vessel 51 such as a dish. While the culture vessel 51 is a box body, a bottom plate of which is square-shaped and an upper part of which is opened, a shape of the bottom plate may be a circular shape or other shapes. On the bottom plate of the culture vessel 51, a culture medium 52 is formed. On the culture medium 52, cells 53 are cultured.

The first observation portion 10 includes a housing 41 housing circuit components excluding an operation and recording portion 30 in FIG. 1. For the housing 41, a sealing structure is adopted so as not to affect the device in an environment of high humidity and a relatively high temperature where the culture is performed, four sides are surrounded by side plates 41a-41d, a bottom plate 41e is arranged on a bottom surface, a transparent plate 41f is arranged on an upper surface such that observation is possible from the device since the upper surface is in a direction of mounting the culture vessel, and the housing 41 has a box shape sealed by the side plates 41a-41d, the bottom plate 41e and the transparent plate 41f. Note that the state where the transparent plate 41f is separated from the side plates 41a-41d is illustrated in FIG. 2 in consideration of easiness to view the drawing, but, actually the transparent plate 41f is brought into contact with the side plates 41a-41d and the structure of sealing an inside of the housing 41 is attained. Note that all or a part of the operation and recording portion 30 may be housed in the housing 41, or may be made extendable to an outside in accordance with workability.

Inside the housing 41, a camera device 43 attached to a camera base 42 is housed. The camera device 43 corresponds to the information acquisition portion 13, the control portion 11 and the communication portion 14 in FIG. 1. Inside the housing 41, an x feed screw 44x for moving the camera device 43 back and forth in the x direction, and a y feed screw 44y for moving the camera device 43 back and forth in the y direction are provided. For the x feed screw 44x, one end is freely turnably supported by a support member 45, and the other end is screwed into a screw hole not illustrated of the camera base 42. By turning the x feed screw 44x, the camera base 42 is freely movable back and forth in the x direction. In addition, for the y feed screw 44y, one end is freely turnably supported by a support member 47, and the other end is screwed into a screw hole not illustrated of a moving member 46 to which the support member 45 is fixed. By turning the y feed screw 44y, the moving member 46 is freely movable back and forth in the y direction. Therefore, by appropriately turning the x and y feed screws 44x and 44y, the camera base 42 can be moved to an arbitrary position in the x and y directions.

The x and y feed screws 44x and 44y are turned by two motors not illustrated respectively, and a movement control circuit 48 can drive the two motors. By a moving mechanism of the camera base 42 including the movement control circuit 48, the moving portion 12 in FIG. 1 is configured. Note that a scan mechanism that changes the position is changeable to various systems, and may be a system of moving by a belt or may be a system of moving by a motor along a rail.

The camera device 43 configuring the image acquisition portion 13a in FIG. 1 includes an optical system 43a configured to fetch light made incident through the transparent plate 41f, and the image pickup device not illustrated is provided on an image forming position of the optical system 43a. The optical system 43a includes a focus lens movable to set a focused state and a zoom lens or the like that varies magnification in focus (not illustrated). Note that the camera device 43 includes a mechanism portion, not illustrated, that drives the lenses and a diaphragm in the optical system 43a.

In the present embodiment, on the transparent plate 41f, the culture vessel 51 can be mounted. A size of the transparent plate 41f, that is, the size of the housing 41, may be a size that allows the culture vessel 51 to be mounted on the transparent plate 41f, for example. While the example where the size of the transparent plate 41f is larger than the culture vessel 51 is illustrated in FIG. 2, the housing 41 can be configured in the size similar to the size of the culture vessel 51, and can be configured in the size and weight similar to the size and weight of a smartphone with excellent portability, for example.

In the present embodiment, the culture vessel 51 may be fixedly arranged on the transparent plate 41f by a support member not illustrated. When the housing is in the sealing structure and is small-sized, the housing can withstand handling such as washing and can be handled as if the housing is a device integrated with the culture vessel.

The camera device 43 can acquire the picked-up image of the cells 53 inside the culture vessel 51 mounted on the transparent plate 41f. In the case where the culture vessel 51 is fixedly arranged on the transparent plate 41f, even when the housing 41 is tilted, a positional relation between the transparent plate 41f and the culture vessel 51 does not change. Therefore, for example, even in the case of performing the work of tilting the culture vessel 51 together with the housing 41 inside a clean bench, since the positional relation between the culture vessel 51 in the state of being fixed on the transparent plate 41f and the optical system 43a of the camera device 43 does not change, the position in the x and y directions of the camera device 43 and the focused state do not change, and the state of the same cell can be continuously observed by the control of fixation or the like of the camera device 43.

The camera device 43 includes a communication portion 49 corresponding to the communication portion 14 in FIG. 1, and can transmit the picked-up image of the cells or the like obtained by image pickup to a device outside the housing 41 through the communication portion 49. Of course, application of providing the housing portion with a display panel and displaying the image pickup result on the display panel is conceivable. As the device outside the housing 41, the operation and recording portion 30 in FIG. 1 may be adopted. The application of providing the operation and recording portion 30 with a display panel and displaying the image pickup result on the display panel is also conceivable. While the example where the operation and recording portion 30 is provided inside the first observation portion 10 is illustrated in FIG. 1, the operation and recording portion 30 may be separated from the first observation portion 10 and arranged outside the housing 41. As such an operation and recording portion 30, a tablet PC or a smartphone or the like may be adopted.

FIG. 4 is an explanatory drawing illustrating an example of a configuration comprising of a tablet PC or a smartphone or the like as one example of the operation and recording portion 30.

As illustrated in FIG. 4, a communication portion 30a is built in the operation and recording portion 30, and a display screen 30b constituted of a liquid crystal panel or the like is provided on a surface. On the display screen 30b, a touch panel not illustrated is provided. The touch panel can generate an operation signal according to a position on the display screen 30b indicated with a finger by the user. The operation signal is supplied to the operation portion 32 configuring the operation and recording portion 30. In the case where the user performs touching or sliding on the display screen 30b, the operation portion 32 can detect various kinds of operations such as a touch position of the user, an operation of closing and separating fingers (a pinch operation), a slide operation, a position reached by the slide operation, a slide direction, and a time period of touching, and transmit the operation signal corresponding to the user operation to the communication portion 49 inside the housing 41 through the communication portion 30a.

In addition, an exclusive mechanical switch mechanism may be provided. The image pickup portion may be moved in the x and y directions by a cross-key and a switch to control a focus direction is provided similarly. In addition, a switch for exposure, the diaphragm and image processing may be provided for photographing, and these operations may be performed by touching. Furthermore, a microphone for voice input may be provided there and the user may perform the operation with voice. Since an information terminal such as a smartphone has an extensive communication function and is high in extensibility as a system control portion by downloading of application software and cooperation with an external server or the like, the operation and recording portion 30 may be put in charge of a lot of the control and the judgement of the present application. That is, a wearable portion may acquire only the image, and the operation and recording portion 30 may determine the work and the operation and recording portion 30 may also cause the first observation portion 10 to perform the movement of the camera device and various kinds of control. Coordinate transformation or the like may be shared or the like by the respective observation portions; however, when the coordinate transformation is performed by the operation and recording portion 30, the structure becomes flexible as a system.

For example, the operation portion 32 can generate a movement control signal for controlling the movement of a photographing range by the camera device 43 based on the user operation, and transmit the movement control signal to the communication portion 49 through the communication portion 30a. The communication portion 49 transfers the received movement control signal to the movement control circuit 48. The movement control circuit 48 controls rotations of the x and y feed screws 44x and 44y based on the received movement control signal. Thus, the camera device 43 can be moved to an arbitrary position within a plane parallel with a surface of the transparent plate 41f.

In addition, the camera device 43 has an autofocus function, and can drive the focus lens of the optical system 43a and cause a focused state to be maintained. Furthermore, the camera device 43 can change the view angle by driving the zoom lens. Note that a zoom operation in the camera device 43 can be also controlled by the user operation. When the user performs the zoom operation by the touch panel or the like, the operation portion 32 transmits a control signal based on the operation to the communication portion 49 through the communication portion 30a. Based on the control signal received by the communication portion 49, the camera device 43 drives the zoom lens and changes the view angle. In this way, the camera device 43 can pick up the image in the visual field range of an arbitrary view angle at the arbitrary position parallel with the surface of the transparent plate 41f, based on the user operation. Note that, instead of the zoom lens, the position of the camera device 43 may be configured to be freely movable in a direction vertical to the surface of the transparent plate 41f.

Further, in the present embodiment, setting of the view angle and the visual field range of the camera device 43 can be also automatically controlled by an acquired image of the second observation portion.

FIG. 3 illustrates one example of the second observation portion 20 in FIG. 1, illustrates the example where the second observation portion 20 is constituted of a glasses-type wearable terminal device (glasses-type terminal device), and illustrates only a main part of performing the observation.

In FIG. 3, at a part of a glassframe 61, a circuit storage portion 62 where respective circuits configuring a part of the control portion 21, the information acquisition portion 23, the communication portion 24 and the display portion 22 in FIG. 1 are stored is disposed. On a front side of a right side lens of left and right lenses fitted to left and right rims not illustrated, a light guide portion 22a supported by the glassframe 61 is provided. In addition, on a side face of the circuit storage portion 62, a display panel 23c configured to emit video light toward an incident surface of the light guide portion 22a is disposed. An emission surface of the light guide portion 22a is arranged at a position corresponding to a partial area of the right lens in front of a right eye 72, in the state where a person wears the glassframe 61 on a face 71.

A display control portion, not illustrated, configuring a part of the display portion 22 stored inside the circuit storage portion 62 is supplied with a video signal from the control portion 21, and causes the video light based on the video signal to be emitted from the display panel 23c toward the incident surface of the light guide portion 22a. The video light is guided inside the light guide portion 22a and emitted from the emission surface. In this way, in a part of the visual field range of the right eye 72, the image based on the video signal from the control portion 21 is visually recognized.

Note that the second observation portion 20 is configured to simultaneously observe an observation target of direct observation and the image based on the inputted video signal, which can be viewed in a part of the visual field range, without obstructing see-through direct observation of the observation target. For example, during various kinds of work pertaining to cell culture, it is possible to directly observe a situation of the work and simultaneously observe the picked-up image of the cell acquired by the first observation portion 10. Also, since the second observation portion 20 in FIG. 3 is a wearable terminal and is a hands-free device, actions of hands and feet are not limited upon the observation, and the image acquired by the first observation portion 10 can be observed without damaging the workability of using both hands freely.

In addition, the second observation portion is contrived in consideration of an advantage of being a glasses type, and a voice input portion configured to collect the voice may be provided together facing a mouth, for example. Furthermore, when a viewing direction of the user (operator) is photographed, the situation of the operation can be determined. Therefore, on a distal end of the circuit storage portion 62, an image pickup lens 23b configuring the image acquisition portion 23a is provided so as to observe the situation of the operation. An optical image from the object is given to the image pickup device of the image acquisition portion 23a provided inside the circuit storage portion 62 through the image pickup lens 23b. By the image pickup device, the picked-up image based on the object optical image can be acquired. In the example in FIG. 3, the image pickup lens 23b is provided on the distal end of a temple part of the glassframe 61 and the temple part is turned to almost the same direction as the face 71 of the person so that the image acquisition portion 23a can pick up the image of the object in the same direction as an observation direction by the eye 72 of the person. Thus, the image acquisition portion 23a can acquire the image corresponding to a work state observed by the person as the picked-up image. As described above, based on the picked-up image acquired by the image acquisition portion 23a, the work is determined.

Note that, for the determination of the work target position by the work determination portion 21a, an index may be provided on the transparent plate 41f or the culture vessel 51 or the like. Note that when a relative positional relation with the culture vessel 51 is known, the index may be provided on any position inside an observation range. The index can be determined by the camera device 43 (image acquisition portion 23a) of the first observation portion 10 by a specific pattern, and an index position may be determined by the camera device 43 (image acquisition portion 23a) of the first observation portion 10 as one of origins of the x and y directions.

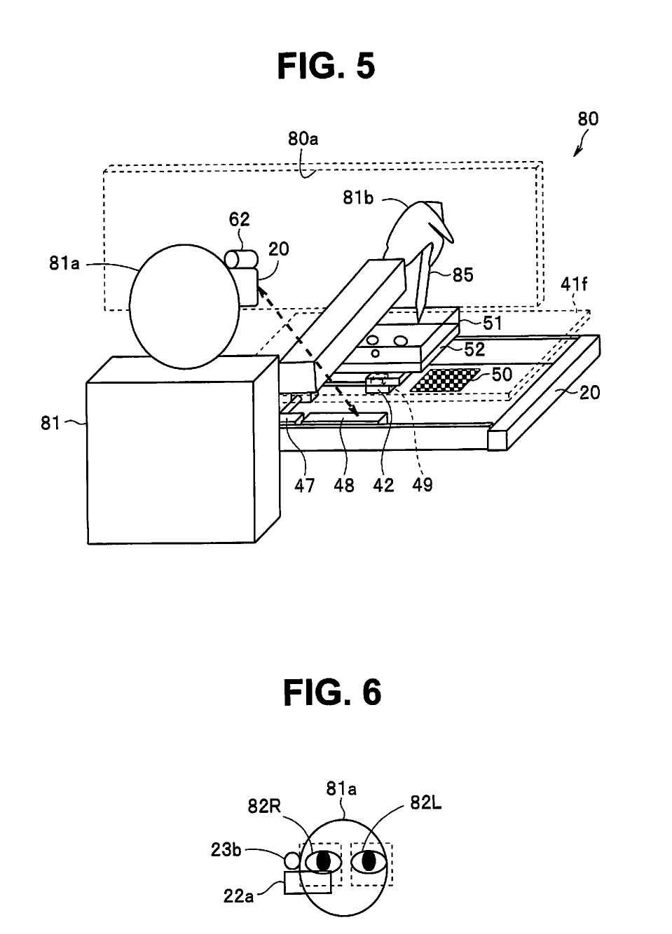

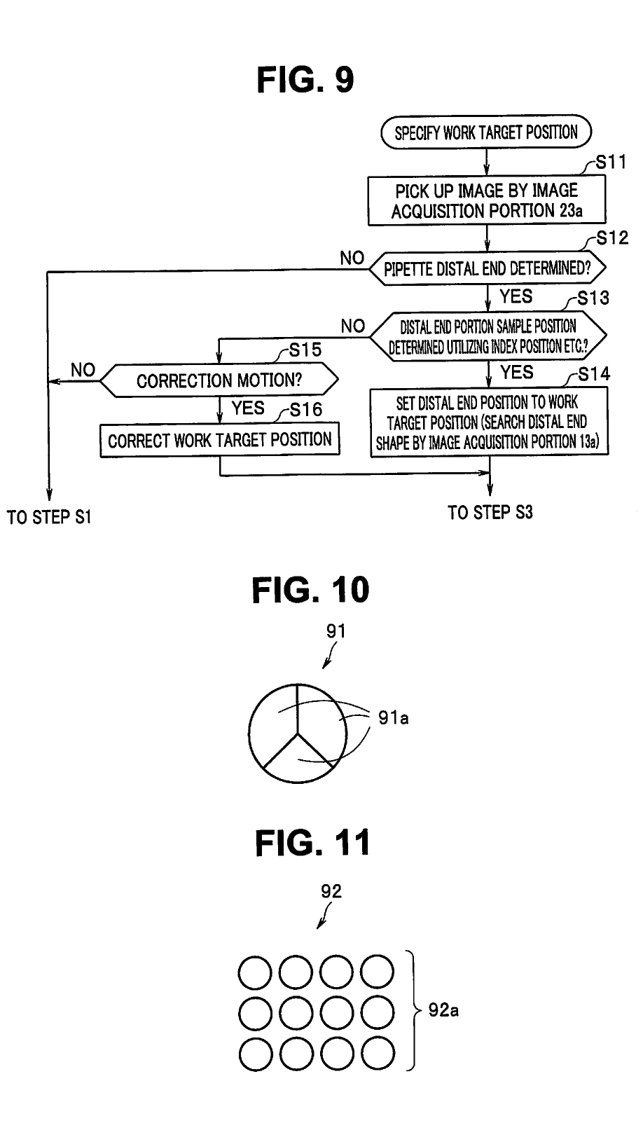

Next, the operation of the embodiment configured in this way will be described with reference to FIG. 5 to FIG. 13. FIG. 5 to FIG. 7 are explanatory drawings for describing the operation of the embodiment, and FIG. 8 and FIG. 9 are flowcharts for describing the operation of the embodiment.

FIG. 5 illustrates the situation of the work inside the clean bench 80. The first observation portion 10 in FIG. 2 is mounted on a work table not illustrated inside the clean bench 80. In addition, the second observation portion 20 in FIG. 3 is mounted on a front face of a face 81a of an operator 81. The image acquisition portion 23a inside the circuit storage portion 62 of the second observation portion 20 picks up the image in the visual field range in the same direction as a line-of-sight direction of the operator 81. The clean bench allows various kinds of work under a clean environment; however, in order to prevent contamination or the like from the outside as much as possible, the work is performed by moving hands in a narrow space or the like and the actual work for the culture is troublesome. It can be said that it is extremely difficult to perform normal microscopy or the like in the situation.

The operator 81 inserts a hand 81b from a front face opening portion 80a of the clean bench 80 into the clean bench 80, and performs the work on the culture vessel 51 or the like mounted on the transparent plate 41f of the first observation portion 10. The example in FIG. 5 illustrates the work of holding a pipette 85 with the hand 81b and performing pipetting to the cell at a predetermined position inside the culture vessel 51.

The camera device 43 (image acquisition portion 23a) of the first observation portion 10 fetches the optical image (in the direction of the transparent plate, that is, in the direction of the mounted sample) from the sample inside the culture vessel 51 mounted on the transparent plate 41f through the optical system 43a, and acquires the picked-up image. The picked-up image is transmitted to the communication portion 24 of the second observation portion 20 through the communication portion 49 (communication portion 14), and supplied to the display portion 22 by the control portion 21. As illustrated in FIG. 6, the display portion 22 causes the operator 81 to visually recognize the picked-up image acquired by the camera device 43 by the light guide portion 22a arranged in front of a right eye 82R of the operator 81.

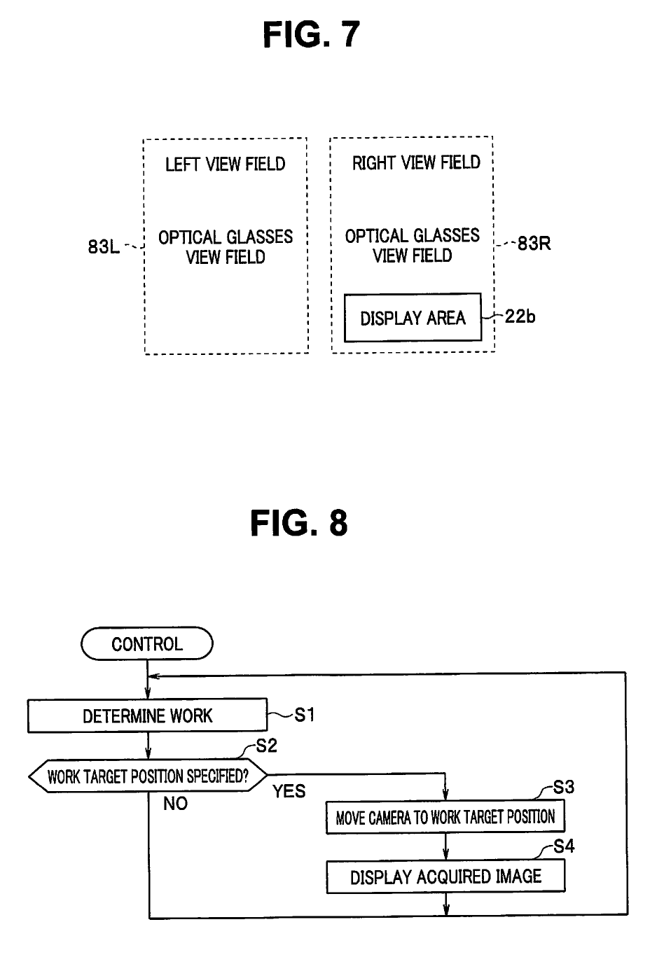

Broken lines surrounding the right eye 82R and a left eye 82L respectively in FIG. 6 illustrate view fields by the right and left eyes 82R and 82L. FIG. 7 describes the view fields. A left view field 83L illustrates the view field by the left eye 82L, and a right view field 83R illustrates the view field by the right eye 82R. The left view field 83L is an optical glasses view field through a left lens (may be a transparent glass and may be even without a glass) not illustrated of the second observation portion 20, and the right view field 83R is an optical glasses view field through a right lens (may be a transparent glass and may be even without a glass) not illustrated of the second observation portion 20. In a part of the right view field 83R, a display area 22b by the light guide portion 22a is provided.

The optical glasses view fields in the left and right view fields 83L and 83R indicate the observation target that the operator 81 is actually viewing, and the display area 22b is the image acquired by the camera device 43 of the first observation portion 10. Therefore, the operator 81 can observe the picked-up image of the sample inside the culture vessel 51 in the display area 22b while performing the work requiring attention using both hands freely in an inconvenient environment while confirming the culture vessel 51 or the like of the work target with the naked eye. It is almost impossible with a conventional microscopic device or the like.

That is, in the case of using the clean bench 80, the sample inside the culture vessel 51 arranged inside the clean bench 80 is observed through the front face opening portion 80a, the sample is difficult to see with the naked eye, and it is relatively difficult to confirm the sample. However, in the present embodiment, the picked-up image acquired by the camera device 43 can be confirmed simultaneously with the observation of the work target with the naked eye, confirmation of the sample is facilitated, and the workability can be remarkably improved.

Further, the moving portion 12 can automatically change the visual field range by the camera device 43 of the first observation portion 10, according to the work of the operator 81. FIG. 8 illustrates the control in this case. Note that, since the control portion 11 of the first observation portion 10 and the control portion 21 of the second observation portion 20 perform processing in cooperation with each other, description is given assuming that the control portion 1 by the control portions 11 and 21 or the like performs the control in the following description.

In step S1 in FIG. 8, the control portion 1 determines the work. The image acquisition portion 23a of the information acquisition portion 23 acquires the picked-up image based on the object optical image made incident through the image pickup lens 23b, and supplies the picked-up image to the work determination portion 21a. The work determination portion 21a determines the content of the work by the operator 81 and the position of the target of the work (work target position) (step S1). In the case where the work target position is specified, the control portion 1 shifts processing from step S2 to step S3, controls the moving portion 12, and moves the camera device 43 such that the work target position is included inside the visual field range. Note that, in step S1, the example of determining the work target position using the picked-up image is illustrated, but, as described above, the voice input portion may be provided in the wearable second observation portion 20 or operation portion 30 and the work target position may be determined by the voice input. In this way, since the glasses-type terminal device used during the work of the culture of cells or the like not only functions as the display portion but also functions as the information acquisition portion that acquires information concerning the work on the sample in the culture vessel from the line-of-sight direction of the user and an instruction of the user and transmits the information concerning the work in order to control the camera device 43, the information of the image or the like concerning the sample during the work can be acquired from the camera device 43 or the like and displayed. For that, the work determination portion configured to acquire the position information of the work target position is provided. Such work determination does not always need to be performed by the glasses-type terminal device alone, and the determination may be made by partially cooperating with other devices by communication, or only the image may be transmitted and all the determination may be consigned to the outside.

The movement control circuit 48 configuring the moving portion 12 controls the rotations of the x and y feed screws 44x and 44y, and moves the camera device 43 to the arbitrary position within the plane parallel with the surface of the transparent plate 41f. The camera device 43, after being moved, drives the focus lens of the optical system 43a and performs autofocus processing. In addition, the control portion 1 can also change the view angle by controlling the optical system 43a of the camera device 43. In this way, the image is picked up by the camera device 43 in the visual field range including the work target position. The picked-up image acquired in this way is displayed in the display area 22b in FIG. 7 by the light guide portion 22a of the display portion 22 of the second observation portion 20 (step S4).

For example, in the case where the operator 81 performs the pipetting work on the cell at the predetermined position inside the culture vessel 51, the control portion 1 can set the visual field range so that the image of the cell which is the target of the pipetting work is picked up.

FIG. 9 illustrates one example of a method of specifying the work target position during the pipetting work.

In addition, since an electric pipette that facilitates the pipetting work of an appropriate amount is commonly used in recent years, the pipette in the present embodiment may be provided with a light emitting portion or the like near the distal end as an exclusive device. When light of a special wavelength or light of a special pattern is emitted from the light emitting portion, the image acquisition portion 23a of the second observation portion 20 and the camera device 43 of the first observation portion 10 can detect a pipette distal end portion more easily. The position of the camera device 43 may be controlled according to a difference between the position and an index position, or the position of the camera device 43 may be controlled so as to track the light.

In the case where an image part of the pipette distal end can be determined, the control portion 1 determines the sample position near the pipette distal end in step S13. Upon the determination, the control portion 1 may utilize the index or the like. In addition, the control portion 1 can determine the sample position near the pipette distal end depending on a kind of the culture vessel or by utilizing an image feature or the like of the culture vessel without utilizing the index or the like. For example, for a specific (right end, for example) edge portion or the like of the vessel in a special shape, the image can be easily determined by the image acquisition portion 23a of the second observation portion 20. When the result is sent to the first observation portion 10, the camera device 43 of the first observation portion 10 can also easily find out and determine a right side edge portion of the culture vessel. Without trying to find out, the position (coordinates) may be recorded as data beforehand and the movement may be made according to the data.

FIG. 10 and FIG. 11 are explanatory drawings illustrating one example of such a culture vessel. A culture vessel 91 in FIG. 10 is divided into three wells 91a. In addition, a culture vessel 92 in FIG. 11 is a multi-dish type microplate divided into 12 wells 92a. For the well 92a in FIG. 11, for example, the one with a diameter of several millimeters for example which is the visual field range of the image acquisition portion 13a can be adopted, and the image of an almost entire area of each well 92a can be picked up at one image pickup of the image acquisition portion 13a. Thus, in this case, the control portion 1 can relatively easily determine the work target position by determining near which well 92a the pipette distal end is positioned.

When the diameter is several millimeters, the well can be almost settled in an image pickup range even at the view angle of the camera device 43 of the first observation portion 10, and by the instruction of a right end, a left end, an upper end or a lower end of the diameter, what is happening at a tip of the pipette can be more accurately observed. For this, the image acquisition portion 23a of the second observation portion 20 can easily determine which dish of multiple dishes or which end portion of the dish the work is at by the image. In addition, the user is sometimes interested not in the sample at the tip of the pipette but in a specific sample, and in such a case, it may be planned to lock the observation position when the pipette distal end is brought to a position off the pipette. Such fine control may be performed with a help of the artificial intelligence or the like. Such work determination does not always need to be performed by the glasses-type terminal device alone, and the determination may be made by partially cooperating with other devices by communication, or consigning all.

In the case of adopting the culture vessel 92 in FIG. 11, in step S2 in FIG. 8, which well 92a is to be set as the work target position can also be specified by the voice. For example, by uttering a number of two digits corresponding to an array of the wells 92a, the control portion 1 may determine the work target position by voice recognition. In addition, the user is sometimes interested not in the sample at the tip of the pipette but in a specific sample, and even in such a case, application control that allows the instruction of “right” and “left” by the voice may be performed.

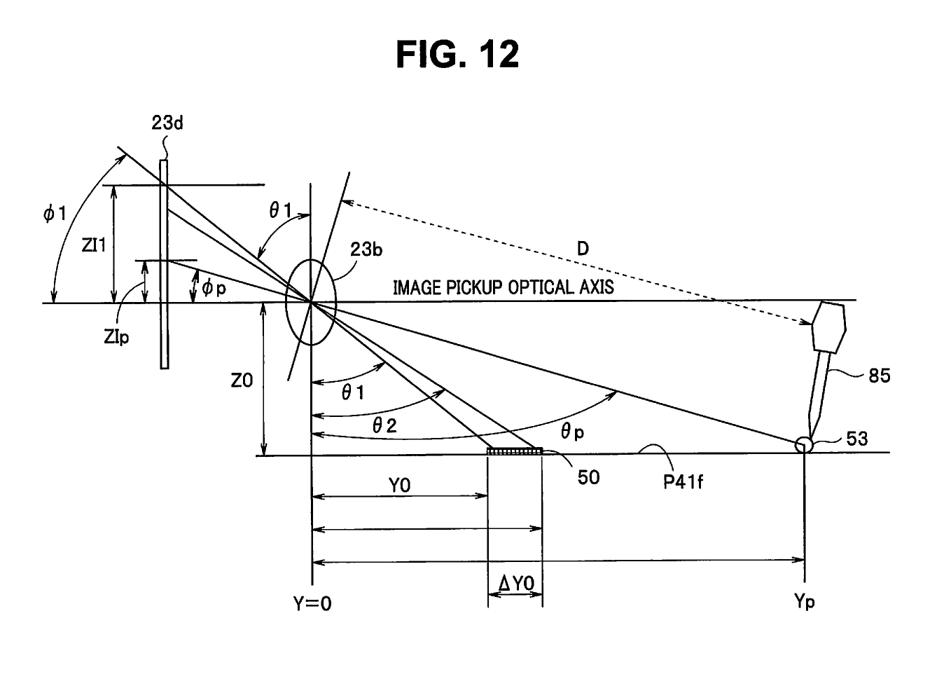

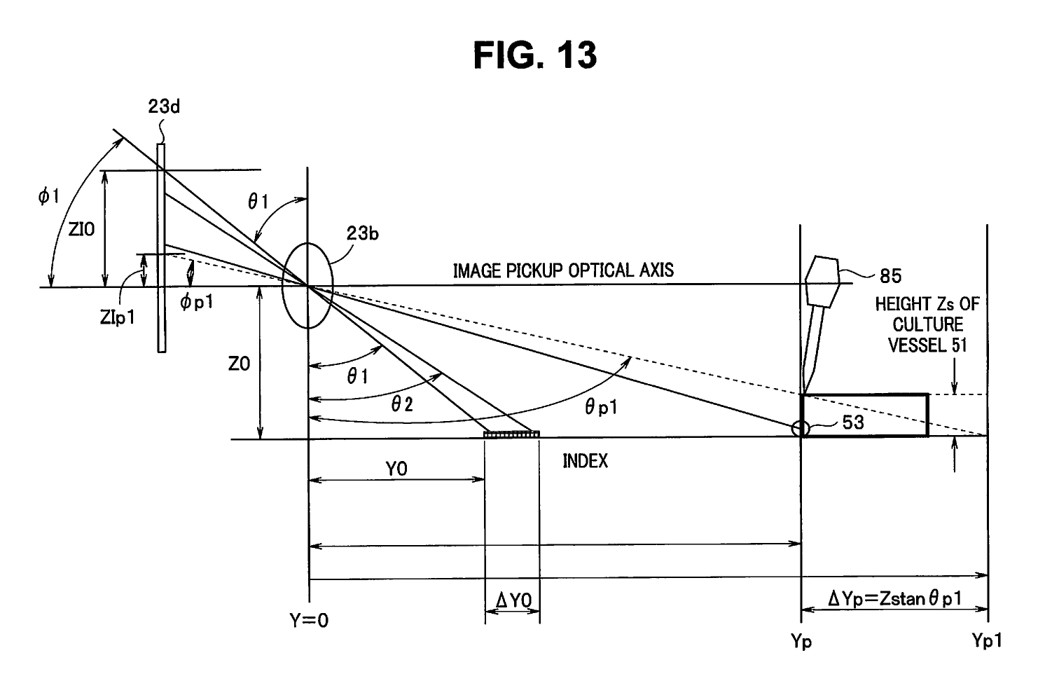

FIG. 12 and FIG. 13 are explanatory drawings illustrating one example of a determination method of a pipette distal end position in the case of utilizing an index 50 formed on the transparent plate 41f.

In FIG. 12, an image pickup surface 23d of the image pickup device configuring the image acquisition portion 23a of the second observation portion 20 is illustrated.

In the example in FIG. 12, it is illustrated that, for the y direction, with a position of a center of the image pickup lens 23b as a reference (Y=0), a distance to the index 50 is Y0, and a distance to the position of the work target by the pipette 85 is Yp. A length in the y direction of the index 50 is ΔY0. In addition, it is assumed that a distance from the center of the image pickup lens 23b to a surface P41f of the transparent plate 41f is Z0. In this case, an equation (1) and an equation (2) below are established. Note that Y0 can be obtained, when the index is a specific specification, by the fact that ΔY0 is known, or by performing conversion from there or measuring the distance to the index or an incident angle D1 of the image of the index.

Y0=Z0×tan θ1 (1)

Yp=Z0×tan θp (2)

An equation (3) below is obtained by modifying the equation (1), and an equation (4) below is obtained from the equation (2) and the equation (3).

Z0=Y0/tan θ1 (3)

Yp=Y0×tan θp/tan θ1 (4)

In addition, θ1 and θp are indicated by an equation (5) or an equation (6) below.

θ1=π/2−φ1 (5)

θp=π/2−φp (6)

Here, φ1 and φp are obtained from optical axis reference positions ZI1 and ZIp on the image pickup surface 23d. By substituting the equations (5) and (6) for the equation (4), the control portion 1 can obtain the work target position for the y direction. The control portion 1 can obtain the work target position by a similar arithmetic operation also for the x direction.

Note that, regardless of the respective equations described above, a distance D in FIG. 12 may be obtained by distance measurement, and the work target position for the y direction may be obtained by an equation (7) below.

Yp=D×sin θp (7)

While FIG. 12 describes that the distal end of the pipette 85 is roughly positioned on the surface P41f of the transparent plate 41f, actually a thickness or the like of the culture vessel 51 needs to be taken into consideration. FIG. 13 illustrates the example in the case where the distal end of the pipette 85 is present at a height position Zs of the culture vessel 51. In this case, instead of the equation (4) described above, an equation (4a) below is derived.

Yp1=Y0×tan θp1/tan θ1 (4a)

Yp is Yp1-ΔYp and an equation (8) below is obtained.

Yp=Yp1−ΔYp=Yp−Zs×tan θp1 (8)

It is θp1=π/2−φp1 and φp can be obtained from an optical axis reference position ZIp1 on the image pickup surface 23d. In this way, even in this case, the control portion 1 can obtain the work target position for the y direction. The control portion 1 can obtain the work target position by a similar arithmetic operation also for the x direction.

When the control portion 1 determines the sample position at the distal end portion of the pipette 85 in step S13 in FIG. 9, in the next step S14, the control portion 1 sets the distal end position of the pipette 85 to the work target position and returns the processing to step S3 in FIG. 8. As described above, in step S3, the control portion 1 controls the moving portion 12 and moves the camera device 43 so that the position of the work target by the pipette 85 is included inside the visual field range of the camera device 43.

Note that, in this case, the control portion 1 may finely adjust the work target position based on the picked-up image by the image acquisition portion 13a of the camera device 43. For example, by coincidence comparison between the image feature of the picked-up image from the camera device 43 and the image feature of a distal end shape of the pipette 85, the work target position may be highly accurately determined. Since a magnification ratio of the image by the camera device 43 is higher than the magnification ratio of the image by the image pickup device inside the second observation portion 20, the work target position can be more highly accurately obtained. In this way, the control portion 1 controls the movement of the camera device 43 so that the work target position of the pipette 85 is included inside the visual field range of the camera device 43. In addition, the user is sometimes interested not in the sample at the tip of the pipette but in a specific sample, and in such a case, it may be planned to bring the pipette first to a position off the pipette and lock the image pickup position of the camera device 43 there. A correction motion to be described later is also effective.

In the case where the position of the distal end portion of the pipette 85 cannot be determined by the picked-up image from the second observation portion 20 in step S13 in FIG. 9, the control portion 1 shifts to step S15, and determines whether or not the instruction of the correction motion to correct the position of the camera device 43 is generated by the user. In the case where the user instructs the correction motion, the control portion 1 controls the moving portion 12, moves the camera device 43 to the work target position according to the instruction (step S16), and returns the processing to step S3 in FIG. 8.

Note that the control portion 1 returns the processing to step S1 in FIG. 8 in the case where the distal end of the pipette 85 cannot be determined in step S12 or in the case where the instruction of the correction motion is not generated in step S15.

In such a manner, in the present embodiment, the housing of the first observation portion is configured in the size excellent in portability, and the culture vessel can be fixedly mounted on the transparent plate that seals the housing. Inside the housing, the image acquisition portion configured to acquire the picked-up image of the sample inside the culture vessel through the transparent plate is provided. Then, the work target position is determined based on the picked-up image from the second observation portion that observes the work on the culture vessel or the like, and based on the determination result, the image acquisition portion is moved such that the work target position is included in the visual field range of the image acquisition portion of the first observation portion. Thus, when the user just performs predetermined work inside the observation range of the second observation portion, the movement of the image acquisition portion of the first observation portion is controlled, the position of the work target enters the image pickup range of the first observation portion, and the picked-up image of the work target position is obtained. For example, when the pipetting work is performed in the cell culture, the image of the target position of the pipetting work is picked up by the image acquisition portion of the high magnification, and the image of the cell or the like can be observed. Moreover, since the first observation portion is excellent in the portability and the culture vessel is fixedly mounted on the housing, even in the case of performing the work of tilting the culture vessel or the like, focusing is easily possible and the observation with a clear picked-up image of the cell or the like is possible. For example, even in the case of taking out a cell vessel from an incubator and performing the work concerning the cell culture in the clean bench or the like, the observation with the picked-up image of the cell or the like can be easily performed simultaneously with the work.

Thus, more careful work is made possible, work progress or the like can be objectively recorded, and accurate work and study can be performed without a failure. By the second observation portion (information acquisition portion), the information obtained from the picked-up image obtained by picking up the image of the work on the sample in the culture vessel is transmitted to the first observation portion as position information concerning the work. The position information concerning the work may be a result obtained by analyzing the image pickup result of a preliminary operation accompanying the work other than analyzing the picked-up image obtained by picking up the image of the work, and does not need to be limited to the image pickup result detected in the wearable portion. That is, the light emitting portion may be detected to attain the position information, or a result indicated by the voice may be defined as the position information. In addition, the first observation portion may calculate the position information not from the position information itself for which the work is determined but from the information concerning the sample or an instrument with which the work is performed.

Further, by configuring the second observation portion by the wearable terminal and adding not only the function of observing the work on the culture vessel or the like but also a display function, the observation with the picked-up image of the cell or the like acquired by the first observation portion can be performed while performing the work. In particular, in the case of configuring the second observation portion by the glasses-type wearable terminal, the observation of the work situation and the observation of the picked-up image of the cell or the like which is the work target can be performed within the range of the view field without moving a line of sight while observing the work, and the workability can be remarkably improved.

While most of the work concerning the culture of the cells or the like is performed in the state where the culture vessel is taken out from the incubator where the culture itself occurs and transferred to the clean bench or the like in the clean environment, confirmation by a fine microscope or the like is also appropriately needed, and it is important to secure cleanliness not affecting the culture throughout the entire environment. It is important to speed up the work for that, and for a subculture operation of the cells for example, many work processes such as temperature change of a culture medium, confirmation of being confluent, shift to a new culture medium, addition of a reagent, incubation, confirmation of a cell state and pipetting exist, and a take-out process from the incubator between the work and a culture state exists. Here, when the cell state is not appropriately observed, success or failure and progress of the work and a culture situation cannot be confirmed. On the other hand, for the observation of a cell level, high magnification photographing is needed. The visual field range of the observation device (microscope or the like) is about a diameter of 2 to 3 millimeters, and it takes a long period of time to observe the entire culture vessel. In addition, in photographing by the microscope, a depth of field is extremely shallow so that many work processes of adjustment or the like are needed for the observation, and improvement of efficiency for such processes is demanded. In this way, an observation system for which the observation device and the glasses-type terminal device are combined, characterized by including the communication portion configured to communicate with the glasses-type terminal device including the display portion, and including the control portion configured to acquire the information concerning the work position to the sample in the culture vessel from the glasses-type terminal device, control the movement of the image acquisition portion configured to acquire the image in the direction where the culture vessel is mounted, cause the picked-up image of the position corresponding to the sample position to be acquired, and cause the glasses-type terminal device to display the image pickup result can be provided. For the position determination and the control to the position, the system is configured with a certain degree of freedom, sometimes one device is in charge of an individual function, sometimes one function is configured over the plurality of devices, and it is needless to say that various applications are possible in a case where one device integrates all the control or in a case where an external device not illustrated integrally performs the control.

### (Modification)

In the first embodiment, the picked-up image acquired by the second observation portion 20 is utilized in order to determine the work. A telephoto lens of the high magnification is needed to observe cells, and image pickup by a lens of a relatively wide angle for observing the work state is needed to determine the work. However, if wide angle photographing and telescopic photographing are possible in the image acquisition portion 13a of the first observation portion 10, the work may be determined by the image obtained by the wide angle photographing in the image acquisition portion 13a, and the position of the visual field range in the telescopic photographing may be controlled by the work determination result. That is, in this case, the second observation portion 20 can be omitted.

Note that, even in this case, the picked-up image of the cell from the first observation portion 10 is displayed at a predetermined display device. In particular, by using the glasses-type wearable terminal as the display device, the workability can be further improved.

### (Modification)

In the first embodiment, the position of the visual field range in the telescopic photographing is controlled based on the determination result of the work determination. However, in the case where the image of a whole or sufficiently wide range of the culture vessel 51 can be picked up with an extremely high resolution in the image acquisition portion 13a of the first observation portion 10, it is conceivable that the work target position is included in the visual field range without moving the position of the visual field range. In this case, the control portion 11 of the first observation portion 10 may perform the control so as to segment, enlarge and display an image part of a predetermined range including the work target position from the picked-up image by the image acquisition portion 13a. That is, in this case, the moving portion 12 can be omitted.

### Second Embodiment

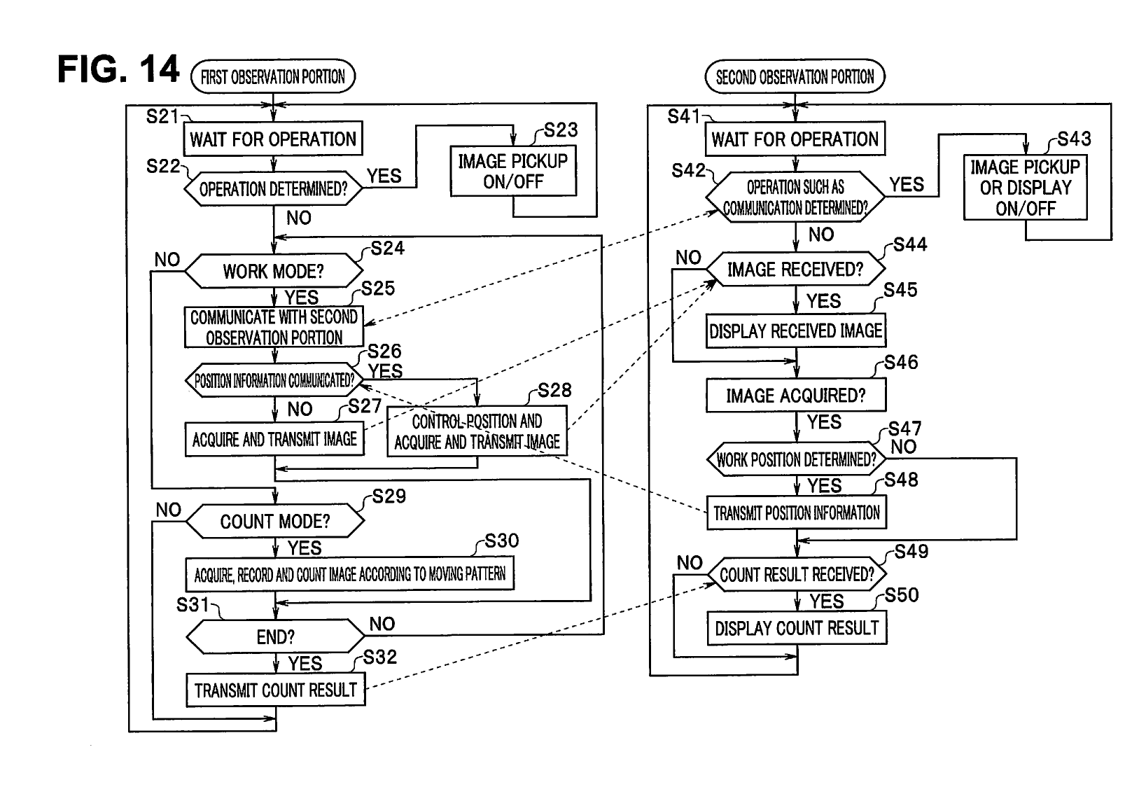

FIG. 14 is a flowchart illustrating an operation flow adopted in a second embodiment. A hardware configuration of the second embodiment is similar to the hardware configuration of the first embodiment. The first observation portion 10 in the present embodiment includes a count mode and a work mode operated similarly to the first embodiment as operation modes. Thus, cell count that is conventionally executed inside the incubator can also be executed inside the clean bench in the present embodiment, and the observation during the work is made possible further.

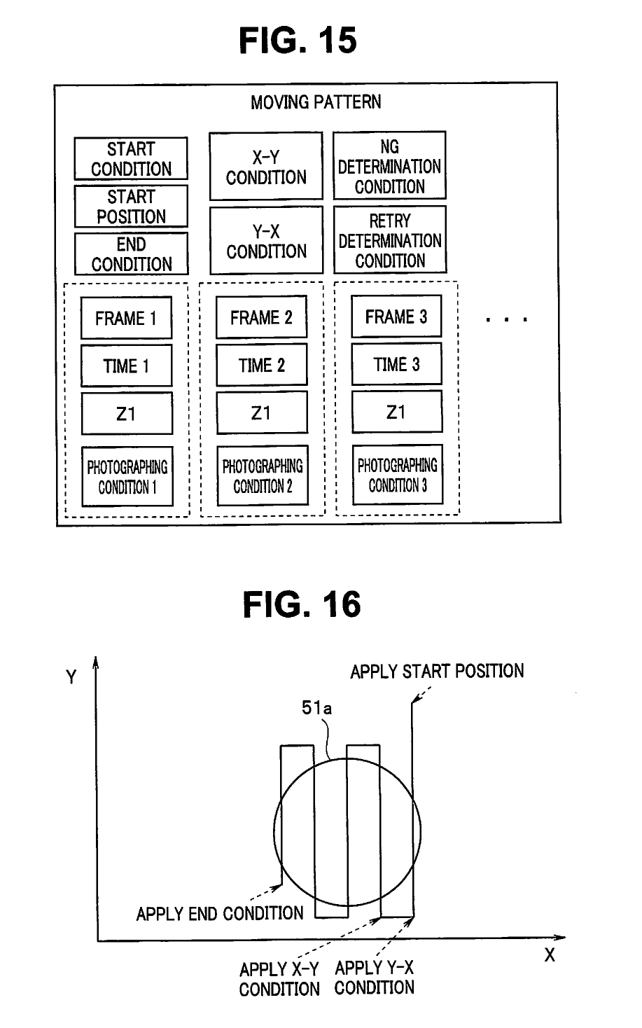

FIG. 14 illustrates the operation of the first observation portion 10 and the second observation portion 20. Note that a line segment connecting each processing in the flow of the first observation portion and each processing in the flow of the second observation portion in FIG. 14 indicates that the communication is performed. In addition, FIG. 15 is an explanatory drawing illustrating moving pattern information adopted in the count mode, and FIG. 16 is an explanatory drawing for describing the movement of the camera device 43 in the count mode.

In the moving pattern recording portion 31a, the moving pattern information illustrated in FIG. 15 is stored. The moving pattern information illustrated in FIG. 15 includes information (movement defining information) on various kinds of conditions for defining a way of the movement of the camera device 43. A start condition in the movement defining information defines the condition of image pickup start in the count mode, that is, image pickup timing, a start position defines an initial position of the camera device 43, and an end condition defines the condition of ending the movement of the camera device 43. In addition, an X-Y condition in the movement defining information defines the condition for switching a moving direction of the camera device 43 from an X direction to a Y direction, and a Y-X condition defines the condition for switching the moving direction of the camera device 43 from the Y direction to the X direction. Furthermore, an NG determination condition in the movement defining information defines the condition in the case where the image pickup result cannot be utilized in count, and is the condition for issuing a warning in the case where the image is picked up at a position other than a normal position or in the case where the image with defective exposure or focus is photographed, for example. In addition, a retry determination condition defines the condition for picking up the image again when NG is determined, and defines the condition for returning to the start position and restarting the image pickup in the case where the NG is determined for example.

In the recording portion 31, information acquired in the count mode is also recorded. Respective areas surrounded by broken lines in FIG. 15 indicate the information obtained at the respective positions of the camera device 43 respectively. For example, when the image is picked up once per second and it takes an hour to pick up the image of the entire culture vessel 51, the image of 3600 frames is photographed in the count mode of one time. Frames 1, 2, . . . in FIG. 15 indicate respective pieces of picked-up image information. In addition, the time indicates the time of the image pickup, Z1 indicates a focus position during photographing, and photographing conditions 1, 2, . . . indicate various kinds of photographing conditions such as the position (XY coordinates) information on the culture vessel 51, an exposure value, and a shutter speed during photographing. In the example in FIG. 15, it is indicated that the image is picked up at a constant focus position (may be a photographing depth, the target position or the information of a Z direction or the like, in addition) in the count mode. In addition, the magnification ratio (view angle) or the like may be recorded.

The control portion 11 of the first observation portion 10 is in a state of waiting for the operation in step S21 in FIG. 14. The first observation portion 10 on which the culture vessel 51 is mounted is mounted inside the clean bench for example and the work is performed. When the operation to the first observation portion 10 is performed, the control portion 11 determines the operation in step S22. The control portion 11 turns off the image pickup in step S23 in the case where the operation of turning off the image pickup is performed, and the control portion 11 turns on the image pickup in step S23 in the case where the operation needing the image pickup is performed. By on/off control in step S23, increase of consumption of the battery 15 when the image pickup is not needed can be suppressed.

On the other hand, the control portion 21 of the second observation portion 20 is in the state of waiting for the operation in step S41 in FIG. 14. When the operation to the second observation portion 20 or the communication from the first observation portion 10 is generated, the control portion 21 determines the operation in step S42. The control portion 21 turns off the image pickup or display in step S43 in the case where the operation of turning off the image pickup or the display is performed, and the control portion 21 turns on the image pickup or the display in step S43 in the case where the state needing the image pickup or the display is generated. By on/off control in step S43, the increase of the consumption of the battery 25 when the image pickup or the display is not needed can be suppressed.

The control portion 11 of the first observation portion 10 determines whether or not the work mode is specified in step S24. In the work mode, the first and second observation portions 10 and 20 can perform the operation similar to the operation in the first embodiment. In the case where the work mode is specified, the control portion 11 communicates with the second observation portion 20 in step S25. Note that, by the communication, the second observation portion 20 can start the image pickup in step S43.

The control portion 11 determines whether or not the position information is communicated in step S26. In the case where the work is determined in the control portion 21 of the second observation portion and the position information of the work target position is transmitted to the first observation portion 10, the control portion 11 shifts the processing to step S28. In the case where the position information of the work target position is not acquired in the work determination by the control portion 21 of the second observation portion, the control portion 11 shifts the processing to step S27.

In step S27, the control portion 11 causes the image acquisition portion 13a to pick up the image without changing the visual field range, and transmits the acquired picked-up image to the second observation portion 20. In addition, in step S28, the control portion 11 causes the visual field range of the image acquisition portion 13a to be changed to the range based on the position information by the moving portion 12, then cause the image to be picked up, and transmits the acquired picked-up image to the second observation portion 20.

The control portion 21 of the second observation portion 20 determines whether or not the picked-up image is received from the first observation portion 10 in step S44. When the picked-up image from the first observation portion 10 is received, the control portion 21 gives the received image to the display portion 22, and causes the image to be displayed in step S45.

The control portion 21 acquires the picked-up image obtained by picking up the image of the work state by the image acquisition portion 23a in step S46 and determines the work. The control portion 21 determines whether or not the work position is determined in step S47, and transmits the position information to the first observation portion 10 in step S48 in the case where the determination result is obtained for the work. In the case where the work position is not determined, the control portion 21 shifts the processing to step S49.

When it is determined that the work mode is not specified in step S24, the control portion 11 of the first observation portion 10 determines whether or not the count mode is specified in step S29. In the present embodiment, similarly to the time of the work mode, the count of the number of cells can be executed in the state of mounting the first observation portion 10 inside the clean bench. For example, when the user operates the operation portion 32 and specifies the count mode, the control portion 11 reads the information on a moving pattern, and executes image acquisition, recording and count processing according to the moving pattern in step S30.

FIG. 16 represents the position in the X direction of the transparent plate 41f on a horizontal axis, represents the position in the Y direction of the transparent plate 41f on a vertical axis, and illustrates the movement of a center position (referred to as the position of the visual field range, hereinafter) of the visual field range of the image acquisition portion 13a in the count mode by straight lines. A circle in FIG. 16 illustrates a culture vessel 51a. Note that an interval of the straight lines illustrating the movement of the position of the visual field range in FIG. 16 is different from an actual interval, and the movement of the position of the visual field range, that is, scan, is actually performed such that the entire area of the culture vessel 51 is photographed.

The control portion 11 reads the information on the moving pattern from the moving pattern recording portion 31a, and moves the center for example of the visual field range of the image acquisition portion 13a to the start position in the information on the moving pattern. In the example of FIG. 16, the control portion 11 moves the visual field range in a negative direction of the Y direction first. When the start condition is satisfied, the control portion 11 picks up the image. The control portion 11 may start the image pickup by detecting an edge side portion of the culture vessel 51a, and in the case where the size of the culture vessel 51a and a mounting position on the transparent plate 41f are defined, may start the image pickup by reaching a position predetermined as the edge side portion of the culture vessel 51a. For the start condition, the timing of the image pickup is determined according to a moving amount of the position of the visual field range, and every time the position of the visual field range is moved by a predetermined distance, the control portion 11 causes the image acquisition portion 13a to acquire the image.

In this way, the control portion 11 repeats the image pickup while moving the position of the visual field range of the image acquisition portion 13a, successively gives the image pickup result to the recording portion 31, and causes the image pickup result to be recorded. In such a manner, the image pickup result surrounded by the respective broken line areas in FIG. 15 is stored. When the position of the visual field range satisfies the X-Y condition, the control portion 11 controls the moving portion 12 and causes the movement of the position of the visual field range to be changed to the X direction. In the example of FIG. 16, the position of the visual field range is changed in the negative direction of the X direction. Hereinafter, similarly, the image pickup is repeated while scanning the culture vessel 51a. When the position of the visual field range satisfies the end condition, the control portion 11 stops the scan, and counts the number of the cells based on the recorded picked-up image. Note that the count of the number of the cells may be executed during the scan.

The control portion 11 determines whether or not the count processing is ended in step S30. When it is ended, a count result is transmitted to the second observation portion 20 (step S31). In the case where the count processing is not ended, the control portion 11 returns the processing from step S30 to step S24.

The control portion 21 of the second observation portion 20 determines whether or not the count result is received in step S48. When the count result is received, the control portion 21 gives the received count result to the display portion 22, and causes the count result to be displayed (step S50).

In this way, in the present embodiment, effects similar to the effects of the first embodiment can be obtained, and the number of the cells can be counted. The count mode can be executed following the work mode for example inside the clean bench, and the culture state of the cells can be extremely easily confirmed. Here, the cell culture is described; however, other than the cells, the application is also possible to a protein experiment of an enzyme antibody technique, and culture observation of bacteria, microalgae, protozoans or the like in addition.

The present invention is not limited as it is to the embodiments described above, and components can be modified and embodied without departing from the gist in an implementation phase. In addition, by an appropriate combination of the plurality of components disclosed in the embodiments, various inventions can be formed. For example, some components of all the components illustrated in the embodiments may be deleted.

Note that, regarding operation flows in the scope of claims, the description and the drawings, even when the operation flows are described using “first”, “next” or the like for convenience, it does not mean that it is essential to perform execution in the order. In addition, it is needless to say that, for respective steps configuring the operation flows, parts not affecting essence of the invention can be appropriately omitted.

Note that, of a technology described here, the control described mainly with the flowcharts can be often set by a program, and is sometimes housed in a recording medium or a recording portion of a semiconductor and the like. As the way of recording to the recording medium or the recording portion, recording may be performed when shipping a product, a distributed recording medium may be utilized, or downloading may be performed through the Internet. In addition, part of various judgement may be performed utilizing the artificial intelligence. In this case, while the judgement is changed according to the result of the deep learning, it is sufficient to make the artificial intelligence learn what judgement is right and what judgement is not according to the situation beforehand, and when the user adds correction to the result of the automatically-made judgement during practical use, a difference between preferable control and non-preferable control can be inputted to the artificial intelligence, and the accuracy of the determination can be improved further.

What is claimed is:

1. An observation device comprising:
an image acquisition portion configured to acquire an image in a direction where a culture vessel is mounted; and
a control portion configured to control the image acquisition portion when a sample position at the time of performing work on a sample in the culture vessel is given, and cause a picked-up image corresponding to the sample position to be acquired.

2. The observation device according to claim 1,
wherein the control portion controls a visual field range of an image acquired by the image acquisition portion based on position information of the sample position.

3. The observation device according to claim 2,
wherein the control portion moves a position of the visual field range by moving the image acquisition portion based on the position information of the sample position, and obtains image output that allows display of an image of a predetermined range including the sample position.

4. The observation device according to claim 1, comprising:
an information acquisition portion configured to acquire information concerning the work on the sample in the culture vessel; and
a work determination portion configured to determine the work based on the information concerning the work and acquire position information of the sample position.

5. The observation device according to claim 4,
wherein the information acquisition portion defines a picked-up image obtained by picking up an image of the work on the sample in the culture vessel as the information concerning the work.

6. The observation device according to claim 5,
wherein the information acquisition portion acquires an image using an image pickup lens of an angle wider than an angle of an image pickup lens adopted in image acquisition in the image acquisition portion.

7. The observation device according to claim 1, comprising
a display portion configured to perform display based on the picked-up image acquired by the control portion.

8. The observation device according to claim 7,
wherein the display portion is constituted of a glasses-type wearable terminal.

9. A glasses-type terminal device used during work for culture, the glasses-type terminal device comprising:
an information acquisition portion configured to acquire information concerning work on a sample in a culture vessel; and
a work determination portion configured to determine the work based on the information concerning the work, and acquire position information of a sample position at the time of performing the work on the sample.

10. The glasses-type terminal device according to claim 9, comprising
a display portion configured to receive image output from an observation portion including an image acquisition portion configured to acquire a picked-up image of the culture vessel mounted on a housing and a control portion configured to receive position information of the sample position, control the image acquisition portion to acquire the picked-up image of a sample in the culture vessel, and obtain the image output that allows display of an image of a predetermined range including the sample position, and perform display based on the received image output.

11. The glasses-type terminal device according to claim 10,
wherein the display portion performs display based on the image output at a lens portion of glasses.

12. An observation device comprising:
an image acquisition portion configured to acquire an image in a direction where a culture vessel is mounted;
a communication portion configured to communicate with a glasses-type terminal device including a display portion; and
a control portion configured to acquire information concerning a sample position at the time of performing work on a sample in the culture vessel from the glasses-type terminal device, control the image acquisition portion to acquire a picked-up image of a position corresponding to the sample position, and cause the glasses-type terminal device to display an image pickup result.

13. An observation system comprising:
a glasses-type terminal device including a display portion;
an image acquisition portion configured to acquire an image in a direction where a culture vessel is mounted;
a communication portion configured to communicate with the glasses-type terminal device; and
a control portion configured to acquire information concerning a sample position at the time of performing work on a sample in the culture vessel from the glasses-type terminal device, control the image acquisition portion to acquire a picked-up image of a position corresponding to the sample position, and cause the glasses-type terminal device to display an image pickup result.

14. An observation method comprising:
a procedure configured to acquire a sample position at the time of performing work on a sample in a culture vessel; and
a procedure configured to control an image acquisition portion configured to acquire an image in a direction where the culture vessel is mounted, and cause a picked-up image corresponding to the sample position to be acquired.

15. A sample position acquisition method comprising:
a procedure configured to acquire information concerning work on a sample in a culture vessel, by a glasses-type terminal device used during the work for culture; and
a procedure configured to determine the work based on the information concerning the work and acquire position information of the sample position at the time of performing the work on the sample.

16. An observation method comprising:
a procedure configured to acquire information concerning a sample position at the time of performing work on a sample in a culture vessel, by a glasses-type terminal device including a display portion;
a procedure configured to control an image acquisition portion configured to acquire an image in a direction where the culture vessel is mounted based on the information concerning the sample position, and cause a picked-up image of a position corresponding to the sample position to be acquired; and
a procedure configured to transmit the acquired picked-up image to the glasses-type terminal device and cause the picked-up image to be displayed at the display portion.

17. A non-transitory computer-readable recording medium, the recording medium recording an observation program for causing a computer to execute:
a procedure configured to acquire a sample position at the time of performing work on a sample in a culture vessel; and
a procedure configured to control an image acquisition portion configured to acquire an image in a direction where the culture vessel is mounted, and cause a picked-up image corresponding to the sample position to be acquired.

18. A non-transitory computer-readable recording medium, the recording medium recording a sample position acquisition program for causing a computer to execute:
a procedure configured to acquire information concerning work on a sample in a culture vessel, by a glasses-type terminal device used during the work for culture; and
a procedure configured to determine the work based on the information concerning the work and acquire position information of the sample position at the time of performing the work on the sample.

19. A non-transitory computer-readable recording medium, the recording medium recording an observation program for causing a computer to execute:
a procedure configured to acquire information concerning a sample position at the time of performing work on a sample in a culture vessel, by a glasses-type terminal device including a display portion;
a procedure configured to control an image acquisition portion configured to acquire an image in a direction where the culture vessel is mounted based on the information concerning the sample position, and cause a picked-up image of a position corresponding to the sample position to be acquired; and
a procedure configured to transmit the acquired picked-up image to the glasses-type terminal device and cause the picked-up image to be displayed at the display portion.
